(19) United States
(12) Patent Application Publication
(10) Pub. No.: US 2021/0005945 A1
(43) Pub. Date: Jan. 7, 2021

(54) BANDPASS FILTER

(71) Applicant: FUJIKURA LTD., Tokyo (JP)

(72) Inventor: Yusuke Uemichi, Sakura-shi (JP)

(73) Assignee: FUJIKURA LTD., Tokyo (JP)

(21) Appl. No.: 17/040,767

(22) PCT Filed: Mar. 8, 2019
(86) PCT No.: PCT/JP2019/009368

§ 371 Date: Sep. 23, 2020

(30) Foreign Application Priority Data
Mar. 28, 2018 (JP) 2018-063121

(51) Int. Cl. H01P 1/207; H01P 3/12

(52) U.S. Cl. CPC H01P 1/207; H01P 3/121

(57) ABSTRACT

Realized is a post-wall waveguide bandpass filter in which a bypass phenomenon is less likely to occur. In a post-wall waveguide bandpass filter (1) including an input part (10a) and an output part (10b), an external post wall (14a1, 14a2, 14b1, 14b2) is provided which is constituted by at least one conductor post that is provided outside a waveguide region (D1) and that short-circuits an outer periphery of an upper wide wall (12a) and an outer periphery of a lower wide wall (12b).

### TECHNICAL FIELD

The present invention relates to a bandpass filter of a post-wall waveguide type (hereinafter, referred to as a post-wall waveguide bandpass filter).

### BACKGROUND ART

Bandpass filters are widely used which cut off electromagnetic waves that fall outside passbands while allowing electromagnetic waves that fall within the passbands to pass therethrough. Bandpass filters which operate in millimeter wave bands are typically implemented as waveguide tubes or waveguides which contain a plurality of resonators coupled in series.

Non Patent Literature 1 discloses a bandpass filter of a metallic waveguide tube type (hereinafter, referred to as a metallic waveguide tube bandpass filter). Non Patent Literature 2 discloses a post-wall waveguide bandpass filter. The post-wall waveguide bandpass filter is more advantageous than the metallic waveguide tube bandpass filter in the following points. That is, the post-wall waveguide bandpass filter is less expensive, smaller in size, and lighter in weight than the metallic waveguide tube bandpass filter.

### CITATION LIST

### Non-Patent Literature

[Non-Patent Literature 1]
Kazuaki YOSHIDA, “Technology and Applications of Microwave Filters,” JRC Review, No. 64, December 2013

[Non-Patent Literature 2]
Y. Uemichi, O. Nukage, K. Nakamura, X. Han, R. Hosono, and S. Amakawa, “Compact and low-loss bandpass filter realized in silica-based post-wall waveguide for 60-GHz application”, IEEE MTT-S IMS, May 2015

### SUMMARY OF INVENTION

### Technical Problem

However, the inventors of the present application have discovered that, in a post-wall waveguide bandpass filter, a bypass phenomenon in which an electromagnetic wave that falls outside a passband passes through the bandpass filter can occur by an edge region (later described) functioning as a bypass waveguide. In a case where such a bypass phenomenon occurs, isolation performance of the bandpass filter deteriorates.

The bypass phenomenon that can occur in the post-wall waveguide bandpass filter will be described below more specifically, with reference to FIGS. 7 and 8. In the following description, in a coordinate system illustrated in each of FIGS. 7 and 8, a positive direction of an x axis (hereinafter, referred to as an x-axis positive direction) will be referred to as “right”, a negative direction of the x axis (hereinafter, referred to as an x-axis negative direction) will be referred to as “left”, a positive direction of a y axis (hereinafter, referred to as a y-axis positive direction) will be referred to as “front”, a negative direction of the y axis (hereinafter, referred to as a y-axis negative direction) will be referred to as “back”, a positive direction of a z axis (hereinafter, referred to as a z-axis positive direction) will be referred to as “up”, and a negative direction of the z axis (hereinafter, referred to as a z-axis negative direction) will be referred to as “down”.

FIG. 7 is an exploded perspective view of a bandpass filter 9. As illustrated in FIG. 7, the bandpass filter 9 includes: a dielectric substrate 91; an upper wide wall 92a provided on an upper surface of the dielectric substrate 91; a lower wide wall 92b provided on a lower surface of the dielectric substrate 91; and a post wall 93 provided inside the dielectric substrate 91. The post wall 93 is constituted by a set of conductor posts arranged in the form of a fence.

FIG. 8 is a plan view of the bandpass filter 9. As illustrated in FIG. 8, the post wall 93 includes six partition wall pairs 931 through 936 in addition to a right narrow wall 930a, a left narrow wall 930b, a front narrow wall 930c, and a back narrow wall 930d. A region D1 having a shape of a rectangular parallelepiped, which region D1 is sandwiched between the wide walls 92a and 92b (not illustrated) on upper and lower sides, respectively, of the region D1 and is surrounded by the narrow walls 930a through 930d on right, left, front, and back sides, respectively, of the region D1, functions as a rectangular waveguide in which an electromagnetic wave is guided. Hereinafter, the region D1 will be referred to as a “waveguide region”.

The waveguide region D1 is partitioned into seven small regions D11 through D17 by the six partition wall pairs 931 through 936. In the small region D11, an input part 90a, via which electromagnetic waves are inputted from a first microstrip line 5 into the waveguide region D1, is provided. Hereinafter, the small region D11 will be referred to as an “input region”. Each of five small regions D12 through D16 functions as a resonator. Hereinafter, each of the small regions D12 through D16 will be referred to as a “resonance region”. In the small region D17, an output part 90b, via which an electromagnetic wave is outputted from the waveguide region D1 to a second microstrip line 6, is provided. Hereinafter, the small region D17 will be referred to as an “output region”.

According to the bandpass filter 9, the five resonance regions D12 through D16 coupled in series function as a bandpass filter of a Chebyshev type, which bandpass filter selectively allows an electromagnetic wave that falls within a specific passband to pass therethrough. Therefore, of electromagnetic waves which have been inputted from the first microstrip line 5 into the input region D11 via the input part 90a, merely an electromagnetic wave which falls within a specific passband is outputted from the output region D17 to the second microstrip line 6 via the output part 90b.

However, a bypass phenomenon can occur in such a bandpass filter 9. That is, a phenomenon can occur in which part of an electromagnetic wave that should be guided from the first microstrip line 5 to the second microstrip line 6 through the waveguide region D1 is guided from the first microstrip line 5 to the second microstrip line 6 through an edge region D2 that exists outside the waveguide region D1. Here, the edge region D2 refers to, in the dielectric substrate 91, a region and a vicinity thereof, which region is sandwiched between an outer edge of the upper wide wall 92a and an outer edge of the lower wide wall 92b (see FIG. 8).

Note that it is considered possible to suppress the bypass phenomenon by increasing a size of each of the upper wide wall 92a and the lower wide wall 92b so that each of the outer edge of the upper wide wall 92a and the outer edge of the lower wide wall 92b is located away from the waveguide region D1. However, employing a solution that the size of each of the upper wide wall 92a and the lower wide wall 92b is increased may cause another problem that a size of the bandpass filter 9 is increased and a cost of producing the bandpass filter 9 is increased.

The present invention has been made in view of the above problem, and an object thereof is to realize a post-wall waveguide bandpass filter in which a bypass phenomenon is less likely to occur, without employing a solution that a size of each of wide walls is increased.

### Solution to Problem

In order to attain the above object, a bandpass filter in accordance with an aspect of the present invention is a bandpass filter including: a dielectric substrate; a first wide wall which is provided on a first main surface of the dielectric substrate; a second wide wall which is provided on a second main surface of the dielectric substrate; a post wall which is provided inside the dielectric substrate; an input part via which an electromagnetic wave is inputted; and an output part via which the electromagnetic wave is outputted, a waveguide region in which the electromagnetic wave inputted via the input part is guided and which includes a plurality of resonance regions being defined inside the dielectric substrate by the first wide wall, the second wide wall, and the post wall, an external post wall which is constituted by at least one conductor post being provided outside the waveguide region and short-circuiting an outer periphery of the first wide wall and an outer periphery of the second wide wall.

### Advantageous Effects of Invention

According to an aspect of the present invention, it is possible to realize a post-wall waveguide bandpass filter in which a bypass phenomenon is less likely to occur, without employing a solution that a size of each of wide walls is increased.

### BRIEF DESCRIPTION OF DRAWINGS

FIG. 1 is an exploded perspective view illustrating a configuration of a bandpass filter in accordance with Embodiment 1 of the present invention.

(a) of FIG. 2 is a plan view of the bandpass filter illustrated in FIG. 1. (b) and (c) of FIG. 2 are each a cross-sectional view of the bandpass filter illustrated in FIG. 1.

FIG. 3 is graph showing frequency dependence of a transmission coefficient in the bandpass filter illustrated in FIG. 1.

FIG. 4 is an exploded perspective view illustrating a configuration of a bandpass filter in accordance with Embodiment 2 of the present invention.

(a) of FIG. 5 is a plan view of the bandpass filter illustrated in FIG. 4. (b) of FIG. 5 is a cross-sectional view of the bandpass filter illustrated in FIG. 4.

FIG. 6 is graph showing frequency dependence of a transmission coefficient in the bandpass filter illustrated in FIG. 4.

FIG. 7 is an exploded perspective view illustrating a configuration of a conventional bandpass filter.

FIG. 8 is a plan view of the bandpass filter illustrated in FIG. 7.

### DESCRIPTION OF EMBODIMENTS

### Embodiment 1

(Configuration of Bandpass Filter)

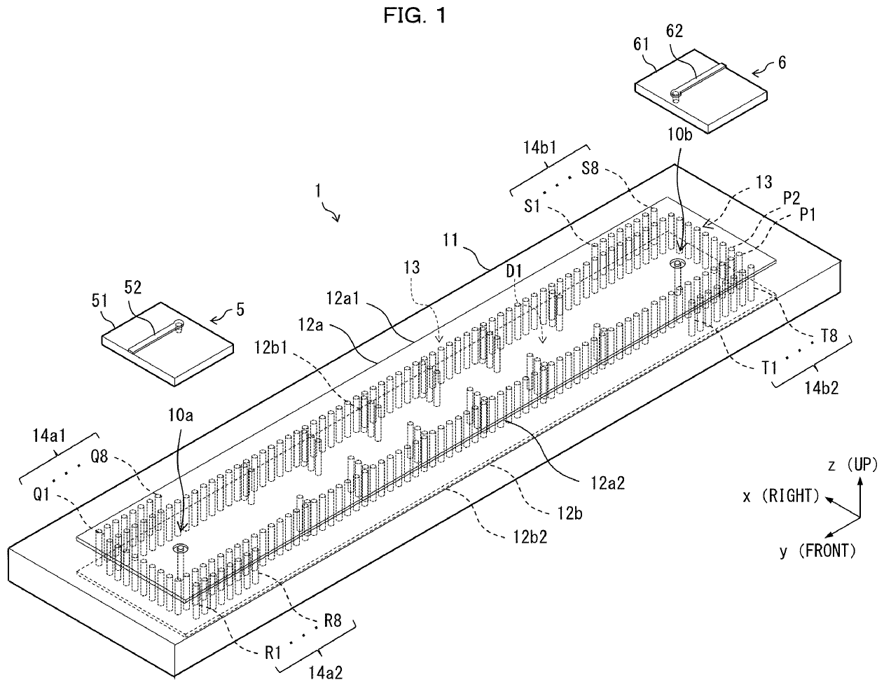

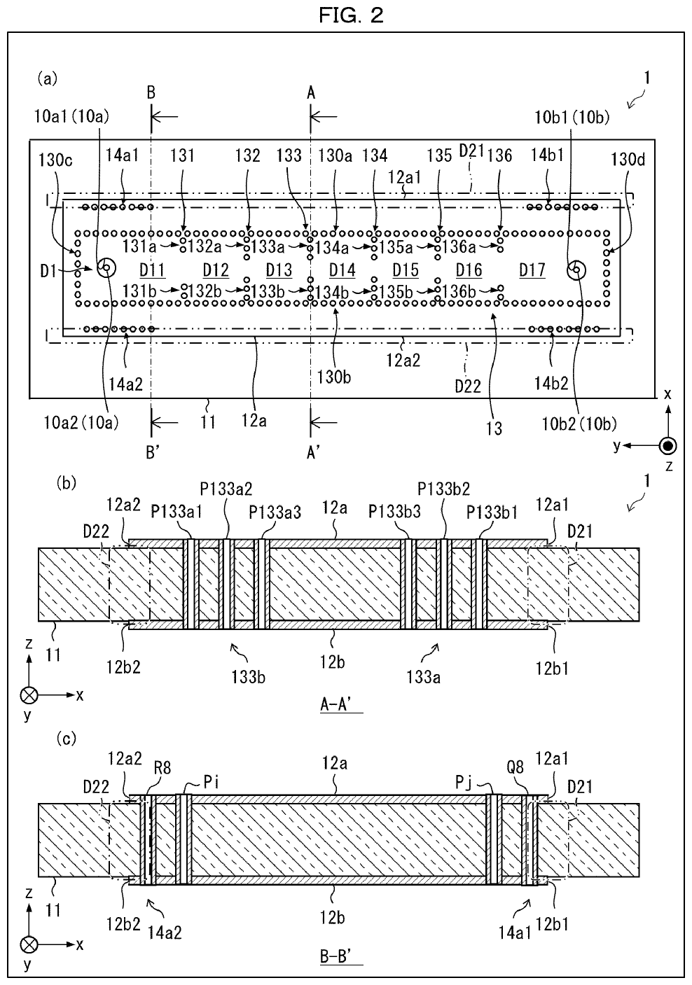

The following description will discuss a configuration of a bandpass filter 1 in accordance with Embodiment 1 of the present invention with reference to FIGS. 1 and 2. FIG. 1 is an exploded perspective view of the bandpass filter 1. (a) of FIG. 2 is a plan view of the bandpass filter 1. (b) and (c) of FIG. 2 are each a cross-sectional view of the bandpass filter 1. Note that FIG. 1 also illustrates a first microstrip line 5 and a second microstrip line 6 which are to be connected to the bandpass filter 1. Note also that a cross section illustrated in (b) of FIG. 2 is a cross section of the bandpass filter 1 taken along an A-A′ line illustrated in (a) of FIG. 2, and a cross section illustrated in (c) of FIG. 2 is a cross section of the bandpass filter 1 taken along a B-B′ line illustrated in (a) of FIG. 2.

As illustrated in FIG. 1, the bandpass filter 1 includes (1) a dielectric substrate 11, (2) an upper wide wall 12a (an example of a “first wide wall” recited in the claims) provided on an upper surface (an example of a “first main surface” recited in the claims) of the dielectric substrate 11, (3) a lower wide wall 12b (an example of a “second wide wall” recited in the claims) provided on a lower surface (an example of a “second main surface” recited in the claims) of the dielectric substrate 11, (4) a post wall 13 provided inside the dielectric substrate 11 and in a region in which the upper wide wall 12a and the lower wide wall 12b overlap each other in a plan view, and (5) external post walls 14a1, 14a2, 14b1, and 14b2 provided inside the dielectric substrate 11 and in a region in which an outer periphery of the upper wide wall 12a and an outer periphery of the lower wide wall 12b overlap each other in a plan view.

The dielectric substrate 11 is a plate-shaped member constituted by a dielectric. In Embodiment 1, a quartz substrate is used as the dielectric substrate 11. Note, however, that a material of the dielectric substrate 11 is not limited to quartz and only needs to be a dielectric. For example, the material of the dielectric substrate 11 may be a resin (for example, a Teflon (registered trademark)-based resin or a liquid crystal polymer resin).

Note that, in the following description, out of six surfaces which constitute a surface of the dielectric substrate 11, each of two surfaces each of which has the largest area will be referred to as a “main surface”. In particular, in a case where it is necessary to distinguish between these two main surfaces, a first one of the two main surfaces, that is, the first main surface will be referred to as an “upper surface”, and a second one of the two main surfaces, that is, the second main surface, which faces the first main surface, will be referred to as a “lower surface”. Out of the six surfaces which constitute the surface of the dielectric substrate 11, each of four surfaces other than the two main surfaces will be referred to as a “side surface”. In particular, in a case where it is necessary to distinguish between these four side surfaces, a first one of the four side surfaces will be referred to as a “right side surface”, a second one of the four side surfaces which second one faces the first one of the four side surfaces will be referred to as a “left side surface”, a third one of the four side surfaces which third one is perpendicular to the first one and the second one of the four side surfaces will be referred to as a “front side surface”, and a fourth one of the four side surfaces which fourth one faces the third one of the four side surfaces will be referred to as a “back side surface”. Note, however, that these designations are for convenience of description and do not impose any restriction on arrangement of the bandpass filter 1. Furthermore, in the following description, a rectangular coordinate system will be employed in which a direction from the left side surface of the dielectric substrate 11 toward the right side surface of the dielectric substrate 11 is an x-axis positive direction, a direction from the back side surface of the dielectric substrate 11 toward the front side surface of the dielectric substrate 11 is a y-axis positive direction, and a direction from the lower surface of the dielectric substrate 11 to the upper surface of the dielectric substrate 11 is a z-axis positive direction.

The upper wide wall 12a is a rectangular film-shaped conductor provided on the upper surface of the dielectric substrate 11. The lower wide wall 12b is a rectangular film-shaped conductor provided on the lower surface of the dielectric substrate 11 so as to face the upper wide wall 12a. In Embodiment 1, a copper film is used as each of the upper wide wall 12a and the lower wide wall 12b. Note, however, that a material of each of the upper wide wall 12a and the lower wide wall 12b is not limited to copper, and only needs to be a conductor. For example, the material of each of the upper wide wall 12a and the lower wide wall 12b may be metal, other than copper, such as aluminum or gold. Further, each of the upper wide wall 12a and the lower wide wall 12b may be a plate-shaped conductor having a sufficient thickness.

The post wall 13 is constituted by a set of a plurality of conductor posts P1, P2, . . . provided inside the dielectric substrate 11. Each conductor post Pi (i=1, 2, . . . ) is a film-shaped (cylindrical) conductor which covers an inner wall of a through-hole that passes through the dielectric substrate 11 up and down, as illustrated in (b) of FIG. 2 ((b) of FIG. 2 illustrates, as an example, conductor posts 133a1 through P133a3 and P133b1 through P133b3 each of which is an aspect of the each conductor post Pi). An upper end and a lower end of the each conductor post Pi are in contact with the upper wide wall 12a and the lower wide wall 12b, respectively, and the each conductor post Pi short-circuits the upper wide wall 12a and the lower wide wall 12b. In Embodiment 1, copper is used as a material of the each conductor post Pi. Note, however, that the material of the each conductor post Pi is not limited to copper, and only needs to be a conductor. For example, the material of the each conductor post Pi may be metal, other than copper, such as aluminum or gold. Further, the each conductor post Pi may be a massive (cylindrical) conductor with which the through-hole that passes through the dielectric substrate 11 up and down is filled. These conductor posts P1, P2, . . . are arranged in the form of a fence, and the post wall 13, which is constituted by the conductor posts P1, P2, . . . , functions as a conductor wall which reflects an electromagnetic wave having a wavelength sufficiently longer than a post interval of the post wall 13. Note that, in Embodiment 1, a diameter of each of the conductor posts P1, P2, . . . is 100 μm, and the post interval (distance between respective central axes of adjacent ones of the conductor posts) of the post wall 13 is 200 μm.

The external post wall 14a1 is constituted by a single conductor post or a set of conductor posts (in Embodiment 1, eight conductor posts Q1, Q2, . . . , Q8), which are located outside a waveguide region D1 (later described) and near an input part 10a and which short-circuit a right outer periphery of the upper wide wall 12a and a right outer periphery of the lower wide wall 12b. (c) of FIG. 2 illustrates the conductor post Q8, which is one of the conductor posts constituting the external post wall 14a1. As used herein, the right outer periphery of the upper wide wall 12a indicates a region which is included in a region obtained by excluding the waveguide region D1 from the upper wide wall 12a and which is located near a right outer edge 12a1. Similarly, the right outer periphery of the lower wide wall 12b indicates a region which is included in a region obtained by excluding the waveguide region D1 from the lower wide wall 12b and which is located near a right outer edge 12b1. These conductor posts Q1, Q2, . . . , Q8 are configured similarly to the conductor posts P1, P2, . . . , which constitute the post wall 13, and the external post wall 14a1 functions as a conductor wall which reflects an electromagnetic wave having a wavelength sufficiently longer than a post interval of the external post wall 14a1. Note that a distance from a central axis of each conductor post Qi (i=1, 2, . . . , 8) to the right outer edge 12a1 of the upper wide wall 12a and a distance from the central axis of each conductor post Qi (i=1, 2, . . . , 8) to the right outer edge 12b1 of the lower wide wall 12b are each set so as to be not more than the post interval of the post wall 13.

The external post wall 14a2 is constituted by a single conductor post or a set of conductor posts (in Embodiment 1, eight conductor posts R1, R2, . . . , R8), which are located outside the waveguide region D1 (later described) and near the input part 10a and which short-circuit a left outer periphery of the upper wide wall 12a and a left outer periphery of the lower wide wall 12b. (c) of FIG. 2 illustrates the conductor post R8, which is one of the conductor posts constituting the external post wall 14a2. As used herein, the left outer periphery of the upper wide wall 12a indicates a region which is included in the region obtained by excluding the waveguide region D1 from the upper wide wall 12a and which is located near a left outer edge 12a2. Similarly, the left outer periphery of the lower wide wall 12b indicates a region which is included in the region obtained by excluding the waveguide region D1 from the lower wide wall 12b and which is located near a left outer edge 12b2. Note that in the following description, in a case where it is not particularly necessary to distinguish between the right outer periphery and the left outer periphery, each of the right outer periphery and the left outer periphery will be simply referred to as an outer periphery. These conductor posts R1, R2, . . . , R8 are configured similarly to the conductor posts P1, P2, . . . , which constitute the post wall 13, and the external post wall 14a2 functions as a conductor wall which reflects an electromagnetic wave having a wavelength sufficiently longer than a post interval of the external post wall 14a2. Note that a distance from a central axis of each conductor post Ri (i=1, 2, . . . , 8) to the left outer edge 12a2 of the upper wide wall 12a and a distance from the central axis of each conductor post Ri (i=1, 2, . . . , 8) to the left outer edge 12b2 of the lower wide wall 12b are each set so as to be not more than the post interval of the post wall 13.

The external post wall 14b1 is constituted by a single conductor post or a set of conductor posts (in Embodiment 1, eight conductor posts S1, S2, . . . , S8), which are located outside the waveguide region D1 (later described) and near an output part 10b and which short-circuit the right outer periphery of the upper wide wall 12a and the right outer periphery of the lower wide wall 12b. These conductor posts S1, S2, . . . , S8 are configured similarly to the conductor posts P1, P2, . . . , which constitute the post wall 13, and the external post wall 14b1 functions as a conductor wall which reflects an electromagnetic wave having a wavelength sufficiently longer than a post interval of the external post wall 14b1. Note that a distance from a central axis of each conductor post Si (i=1, 2, . . . , 8) to the right outer edge 12a1 of the upper wide wall 12a and a distance from the central axis of each conductor post Si (i=1, 2, . . . , 8) to the right outer edge 12b1 of the lower wide wall 12b are each set so as to be not more than the post interval of the post wall 13.

The external post wall 14b2 is constituted by a single conductor post or a set of conductor posts (in Embodiment 1, eight conductor posts T1, T2, . . . , T8), which are located outside the waveguide region D1 (later described) and near the output part 10b and which short-circuit the left outer periphery of the upper wide wall 12a and the left outer periphery of the lower wide wall 12b. These conductor posts T1, T2, . . . , T8 are configured similarly to the conductor posts P1, P2, . . . , which constitute the post wall 13, and the external post wall 14b2 functions as a conductor wall which reflects an electromagnetic wave having a wavelength sufficiently longer than a post interval of the external post wall 14b2. Note that a distance from a central axis of each conductor post Ti (i=1, 2, . . . , 8) to the left outer edge 12a2 of the upper wide wall 12a and a distance from the central axis of each conductor post Ti (i=1, 2, . . . , 8) to the left outer edge 12b2 of the lower wide wall 12b are each set so as to be not more than the post interval of the post wall 13.

Note that, in Embodiment 1, each of the external post walls 14a1, 14a2, 14b1, and 14b2 is constituted by eight conductor posts. However, according to a bandpass filter in accordance with an embodiment of the present invention, the number of conductor posts is only necessary to be at least one. For example, in a case where each of the external post walls 14a1, 14a2, 14b1, and 14b2 is constituted by a small number of conductor posts (for example, a single conductor post), each of the external post walls 14a1, 14a2, 14b1, and 14b2 does not function as a conductor wall which reflects an electromagnetic wave. However, even in a case where each of the external post walls 14a1, 14a2, 14b1, and 14b2 is constituted by a small number of conductor posts, it is possible to prevent an electromagnetic wave from propagating in an edge region (later described) because each of the external post walls 14a1, 14a2, 14b1, and 14b2 short-circuits the outer periphery of the upper wide wall 12a and the outer periphery of the lower wide wall 12b which face each other.

A configuration of the post wall 13 will be described below with reference to FIG. 2. As illustrated in (a) of FIG. 2, the post wall 13 includes six partition wall pairs, that is, first through sixth partition wall pairs 131 through 136 in addition to a right narrow wall 130a, a left narrow wall 130b, a front narrow wall 130c, and a back narrow wall 130d. Note that each of the front narrow wall 130c and the back narrow wall 130d is sometimes referred to as a short wall.

Each of the right narrow wall 130a and the left narrow wall 130b is constituted by a subset of the conductor posts P1, P2, . . . , that is, constituted by two or more of the conductor posts P1, P2, . . . which two or more are arranged in the form of a fence along the y axis. The right narrow wall 130a is located on a right side (in the x-axis positive direction) of a center of the dielectric substrate 11 so as to be parallel to a yz plane. On the other hand, the left narrow wall 130b is located on a left side (in the x-axis negative direction) of the center of the dielectric substrate 11 so as to be parallel to the yz plane.

Each of the front narrow wall 130c and the back narrow wall 130d is constituted by a subset of the conductor posts P1, P2, . . . , that is, constituted by two or more of the conductor posts P1, P2, . . . which two or more are arranged in the form of a fence along the x axis. The front narrow wall 130c is located on a front side (in the y-axis positive direction) of the center of the dielectric substrate 11 so as to be parallel to a zx plane. On the other hand, the back narrow wall 130d is located on a back side (in the y-axis negative direction) of the center of the dielectric substrate 11 so as to be parallel to the zx plane.

A region D1 having a shape of a rectangular parallelepiped, which region D1 is sandwiched between the wide walls 12a and 12b on upper and lower sides, respectively, of the region D1 and is surrounded by the narrow walls 130a through 130d on right, left, front, and back sides, respectively, of the region D1, functions as a rectangular waveguide in which an electromagnetic wave inputted via the input part 10a (later described) is guided. Hereinafter, the region D1 will be referred to as a “waveguide region”.

The first partition wall pair 131 is constituted by a first right partition wall 131a and a first left partition wall 131b. Each of the first right partition wall 131a and the first left partition wall 131b is constituted by a subset of the conductor posts P1, P2, . . . , that is, constituted by two or more of the conductor posts P1, P2, . . . (in Embodiment 1, two conductor posts) which two or more are arranged in the form of a fence along the x axis. The first right partition wall 131a is located on a back side of the front narrow wall 130c and is located on the right side (in the x-axis positive direction) of the center of the dielectric substrate 11 so as to be parallel to the zx plane. The first left partition wall 131b is located on the back side of the front narrow wall 130c and is located on the left side (in the x-axis negative direction) of the center of the dielectric substrate 11 so as to be parallel to the zx plane. A distance from the front narrow wall 130c to the first right partition wall 131a and a distance from the front narrow wall 130c to the first left partition wall 131b are identical to each other. Further, a left end of the first right partition wall 131a (an end located in the x axis negative direction) and a right end of the first left partition wall 131b (an end located in the x-axis positive direction) are spaced apart from each other.

The second partition wall pair 132 is constituted by a second right partition wall 132a and a second left partition wall 132b. Each of the second right partition wall 132a and the second left partition wall 132b is constituted by a subset of the conductor posts P1, P2, . . . , that is, constituted by two or more of the conductor posts P1, P2, . . . (in Embodiment 1, three conductor posts) which two or more are arranged in the form of a fence along the x axis. The second right partition wall 132a is located on a back side of the first right partition wall 131a and is located on the right side (in the x-axis positive direction) of the center of the dielectric substrate 11 so as to be parallel to the zx plane. The second left partition wall 132b is located on a back side of the first left partition wall 131b and is located on the left side (in the x-axis negative direction) of the center of the dielectric substrate 11 so as to be parallel to the zx plane. A distance from the front narrow wall 130c to the second right partition wall 132a and a distance from the front narrow wall 130c to the second left partition wall 132b are identical to each other. Further, a left end of the second right partition wall 132a (an end located in the x axis negative direction) and a right end of the second left partition wall 132b (an end located in the x-axis positive direction) are spaced apart from each other.

The third partition wall pair 133, which is located on a back side of the second partition wall pair 132, is configured similarly to the second partition wall pair 132. The fourth partition wall pair 134, which is located on a back side of the third partition wall pair 133, is configured similarly to the second partition wall pair 132. The fifth partition wall pair 135, which is located on a back side of the fourth partition wall pair 134, is configured similarly to the second partition wall pair 132. The sixth partition wall pair 136, which is located on a back side of the fifth partition wall pair 135, is configured similarly to the first partition wall pair 131. These six partition wall pairs, that is, the first through sixth partition wall pairs 131 through 136 are arranged at regular intervals along the y axis.

The waveguide region D1 as has been described is partitioned into seven small regions D11 through D17 by the six partition wall pairs, that is, the first through sixth partition wall pairs 131 through 136.

In the small region D11, which is sandwiched between the front narrow wall 130c and the first partition wall pair 131 on front and back sides, respectively, of the small region D11, of the waveguide region D1, the input part 10a is provided. The input part 10a is constituted by an opening 10al, which is provided in the upper wide wall 12a, and a blind via 10a2, which is provided in the dielectric substrate 11 through the opening 10al. The blind via 10a2 is electrically insulated from both the upper wide wall 12a and the lower wide wall 12b. The blind via 10a2 is caused to pass through a dielectric layer 51 of the first microstrip line 5 and is connected to a signal line 52 of the first microstrip line 5, as illustrated in FIG. 1. In this case, electromagnetic waves which have been guided in the first microstrip line 5 are input into the small region D11 via the input part 10a. Hereinafter, the small region D11 will be referred to as an “input region”. The blind via 10a2 is configured similarly to the each conductor post Pi, except that the blind via 10a2 is not caused to pass through the dielectric substrate 11 and one end of the blind via 10a2 (an end located in the z-axis negative direction) is located inside the dielectric substrate 11.

In the waveguide region D1, the small region D12, which is sandwiched between the first partition wall pair 131 and the second partition wall pair 132 on front and back sides, respectively, of the small region D12, functions as a first resonator. Hereinafter, the small region D12 will be referred to as a “first resonance region”. The first resonance region D12 is coupled to the above-described input region D11 with a gap between the first right partition wall 131a and the first left partition wall 131b serving as a coupling window.

In the waveguide region D1, the small region D13, which is sandwiched between the second partition wall pair 132 and the third partition wall pair 133 on front and back sides, respectively, of the small region D13, functions as a second resonator. Hereinafter, the small region D13 will be referred to as a “second resonance region”. The second resonance region D13 is coupled to the above-described first resonance region D12 with a gap between the second right partition wall 132a and the second left partition wall 132b serving as a coupling window.

In the waveguide region D1, the small region D14, which is sandwiched between the third partition wall pair 133 and the fourth partition wall pair 134 on front and back sides, respectively, of the small region D14, functions as a third resonator. Hereinafter, the small region D14 will be referred to as a “third resonance region”. The third resonance region D14 is coupled to the above-described second resonance region D13 with a gap between a third right partition wall 133a and a third left partition wall 133b serving as a coupling window.

In the waveguide region D1, the small region D15, which is sandwiched between the fourth partition wall pair 134 and the fifth partition wall pair 135 on front and back sides, respectively, of the small region D15, functions as a fourth resonator. Hereinafter, the small region D15 will be referred to as a “fourth resonance region”. The fourth resonance region D15 is coupled to the above-described third resonance region D14 with a gap between a fourth right partition wall 134a and a fourth left partition wall 134b serving as a coupling window.

In the waveguide region D1, the small region D16, which is sandwiched between the fifth partition wall pair 135 and the sixth partition wall pair 136 on front and back sides, respectively, of the small region D16, functions as a fifth resonator. Hereinafter, the small region D16 will be referred to as a “fifth resonance region”. The fifth resonance region D16 is coupled to the above-described fourth resonance region D15 with a gap between a fifth right partition wall 135a and a fifth left partition wall 135b serving as a coupling window.

In the small region D17, which is sandwiched between the sixth partition wall pair 136 and the back narrow wall 130d on front and back sides, respectively, of the small region D17, of the waveguide region D1, the output part 10b is provided. The output part 10b is constituted by an opening 10b1, which is provided in the upper wide wall 12a, and a blind via 10b2, which is provided in the dielectric substrate 11 through the opening 10b1. The blind via 10b2 is electrically insulated from both the upper wide wall 12a and the lower wide wall 12b. The blind via 10b2 is caused to pass through a dielectric layer 61 of the second microstrip line 6 and is connected to a signal line 62 of the second microstrip line 6, as illustrated in FIG. 1. In this case, an electromagnetic wave which has been guided in the small region D17 is outputted to the second microstrip line 6 via the output part 10b. Hereinafter, the small region D17 will be referred to as an “output region”. The output region D17 is coupled to the above-described fifth resonance region D16 with a gap between a sixth right partition wall 136a and a sixth left partition wall 136b serving as a coupling window. The blind via 10b2 is configured identically to the blind via 10a2.

According to the bandpass filter 1, the five resonance regions D12 through D16 coupled in series function as a bandpass filter of a Chebyshev type, which bandpass filter selectively allows an electromagnetic wave that falls within a specific passband to pass therethrough. Therefore, of electromagnetic waves which have been inputted from the first microstrip line 5 into the input region D11 via the input part 10a, merely an electromagnetic wave which falls within a specific passband is outputted from the output region D17 to the second microstrip line 6 via the output part 10b.

In Embodiment 1, a bandpass filter including the five resonance regions D12 through D15 is realized by partitioning the waveguide region D1 with use of the six partition wall pairs, that is, the first through sixth partition wall pairs 131 through 136, but the present invention is not limited to such a configuration. Namely, by partitioning the waveguide region D1 with use of n (n is any natural number of 3 or more) partition wall pairs, it is possible to realize a bandpass filter including n−1 resonance regions. For example, (1) a bandpass filter including two resonance regions may be realized by partitioning the waveguide region D1 with use of three partition wall pairs, (2) a bandpass filter including three resonance regions may be realized by partitioning the waveguide region D1 with use of four partition wall pairs, or (3) a bandpass filter including four resonance regions may be realized by partitioning the waveguide region D1 with use of five partition wall pairs.

Further, in Embodiment 1, the input part 10a is realized by the opening 10a1 and the blind via 10a2 so that electromagnetic waves which have been guided in the first microstrip line 5 are inputted into the bandpass filter 1, but the present invention is not limited to such a configuration. That is, the input part 10a may be realized merely by the opening 10a1 so that electromagnetic waves which have been guided in a waveguide tube are inputted into the bandpass filter 1. In this case, a shape and a size of the opening 10a1 are determined according to a shape and a size of an output opening of the waveguide tube. Note that, in a case where electromagnetic waves which have been guided in a coplanar line are inputted into the bandpass filter 1, the input part 10a may be constituted by the opening 10a1 and the blind via 10a2, as in Embodiment 1.

Alternatively, the bandpass filter in accordance with an embodiment of the present invention may employ, instead of the input part 10a, an input part (transitions between printed transmission lines and SIW) illustrated in each of “a” through “c” of FIG. 5 of Non-Patent Literature 3 (M. Bozzi, A. Georgiadis, and K. Wu, “Review of substrate-integrated waveguide circuits and antennas”, IET Microw. Antennas Propag., 2011, Vol. 5, Iss. 8, pp. 909-920.) may be employed.

The input part illustrated in “a” of FIG. 5 of Non-Patent Literature 3 is obtained by arranging the bandpass filter 1 in accordance with Embodiment 1 such that (i) the front narrow wall 130c is omitted, (ii) one of the wide walls is stretched in a direction away from the first resonance region, and (iii) a width of the one of the wide walls is narrowed in a tapered shape. Via the input part, an electromagnetic wave which has been guided in a strip-shaped conductor that is narrowed in a tapered shape is inputted into a bandpass filter.

The input part illustrated in “b” of FIG. 5 of Non-Patent Literature 3 is obtained by arranging the bandpass filter 1 in accordance with Embodiment 1 such that (i) the front narrow wall 130c is omitted, (ii) one of the wide walls is stretched in a direction away from the first resonance region, and (iii) part of the film-shaped conductor which constitutes the one of the wide walls is removed. By part of the film-shaped conductor being removed, the film-shaped conductor is separated into (i) a strip-shaped conductor which extends to one end of the bandpass filter and (ii) a wide wall which is electrically insulated from the strip-shaped conductor. Further, a blind via is provided to an end of the strip-shaped conductor which end is located on a first resonance region side. Via the input part, an electromagnetic wave which has been guided in the strip-shaped conductor is inputted into the bandpass filter.

The input part illustrated in “c” of FIG. 5 of Non-Patent Literature 3 is obtained by arranging the bandpass filter 1 in accordance with Embodiment 1 such that (i) the front narrow wall 130c is omitted, (ii) one of the wide walls is stretched in a direction away from the first resonance region, and (iii) part of the film-shaped conductor which constitutes the one of the wide walls is removed. By part of the film-shaped conductor being removed, a coplanar line which extends to one end of the bandpass filter is formed to the film-shaped conductor. Via the input part, an electromagnetic wave which has been guided in the coplanar line is inputted into the bandpass filter.

Similarly, in Embodiment 1, the output part 10b is realized by the opening 10b1 and the blind via 10b2 so that an electromagnetic wave which has passed through the bandpass filter 1 is outputted to the second microstrip line 6, but the present invention is not limited such a configuration. That is, the output part 10b may be realized merely by the opening 10b1 so that an electromagnetic wave which has passed through the bandpass filter 1 is outputted to a waveguide tube. In this case, a shape and a size of the opening 10b1 are determined according to a shape and a size of an input opening of the waveguide tube. Note that, in a case where an electromagnetic wave which has passed through the bandpass filter 1 is inputted into a coplanar line, the output part 10b may be constituted by the opening 10b1 and the blind via 10b2, as in Embodiment 1. Alternatively, the bandpass filter in accordance with an embodiment of the present invention may employ, instead of the output part 10b, an output part (transitions between printed transmission lines and SIW) illustrated in each of “a” through “c” of FIG. 5 of Non-Patent Literature 3.

(Features of Bandpass Filter)

It is noteworthy that the bandpass filter 1 in accordance with Embodiment 1 has the following configuration.

(1) The external post wall 14a1 is provided which is constituted by the conductor posts Q1, Q2, . . . , Q8, which are located outside the waveguide region D1 and on a right side of the input part 10a and which short-circuit the outer periphery of the upper wide wall 12a and the outer periphery of the lower wide wall 12b (specifically, short-circuit a front end part of the right outer periphery of the upper wide wall 12a and a front end part of the right outer periphery of the lower wide wall 12b). The external post wall 14b1 is provided which is constituted by the conductor posts S1, S2, . . . , S8, which are located outside the waveguide region D1 and on a right side of the output part 10b and which short-circuit the outer periphery of the upper wide wall 12a and the outer periphery of the lower wide wall 12b (specifically, short-circuit a back end part of the right outer periphery of the upper wide wall 12a and a back end part of the right outer periphery of the lower wide wall 12b).

(2) The external post wall 14a2 is provided which is constituted by the conductor posts R1, R2, . . . , R8, which are located outside the waveguide region D1 and on a left side of the input part 10a and which short-circuit the outer periphery of the upper wide wall 12a and the outer periphery of the lower wide wall 12b (specifically, short-circuit a front end part of the left outer periphery of the upper wide wall 12a and a front end part of the left outer periphery of the lower wide wall 12b). The external post wall 14b2 is provided which is constituted by the conductor posts T1, T2, . . . , T8, which are located outside the waveguide region D1 and on a left side of the output part 10b and which short-circuit the outer periphery of the upper wide wall 12a and the outer periphery of the lower wide wall 12b (specifically, short-circuit a back end part of the left outer periphery of the upper wide wall 12a and a back end part of the left outer periphery of the lower wide wall 12b).

According to the above configuration, each of the external post walls 14a1, 14a2, 14b1, and 14b2 prevents an electromagnetic wave from propagating in the edge region which is sandwiched between the outer periphery of the upper wide wall 12a and the outer periphery of the lower wide wall 12b. More specifically, each of the external post wall 14a1 and the external post wall 14b1 prevents an electromagnetic wave from propagating in an edge region D21 (see FIG. 2) which is a region and a vicinity thereof which region is sandwiched between the right outer periphery of the upper wide wall 12a and the right outer periphery of the lower wide wall 12b. Each of the external post wall 14a2 and the external post wall 14b2 prevents an electromagnetic wave from propagating in an edge region D22 (see FIG. 2) which is a region and a vicinity thereof which region is sandwiched between the left outer periphery of the upper wide wall 12a and the left outer periphery of the lower wide wall 12b. Therefore, a bypass phenomenon is less likely to occur in the bandpass filter 1 in accordance with Embodiment 1. That is, in the bandpass filter 1 in accordance with Embodiment 1, a phenomenon is less likely to occur in which part of an electromagnetic wave that should be guided from the first microstrip line 5 to the second microstrip line 6 through the waveguide region D1 is guided from the first microstrip line 5 to the second microstrip line 6 through any of the edge regions D21 and D22, as compared with the bandpass filter 9 which is conventional bandpass filter.

Note that, in Embodiment 1, a configuration is employed in which the external post walls 14a1 and 14b1, each of which is for preventing an electromagnetic wave from propagating in the edge region D21, and the external post walls 14a2 and 14b2, each of which is for preventing an electromagnetic wave from propagating in the edge region D22, are both used. However, one of these two post wall pairs can be omitted. That is, it is possible to suppress a bypass phenomenon even by employing any one of (i) a configuration in which merely the external post walls 14a1 and 14b1, each of which is for preventing an electromagnetic wave from propagating in the edge region D21, are used and (ii) a configuration in which merely the external post walls 14a2 and 14b2, each of which is for preventing an electromagnetic wave from propagating in the edge region D22, are used.

Further, in Embodiment 1, a configuration is employed in which the external post wall 14a1, which is located near the input part 10a, and the external post wall 14b1, which is located near the output part 10b, are both used to prevent an electromagnetic wave from propagating in the edge region D21. However, one of these two external post walls 14a1 and 14b1 can be omitted. That is, it is possible to prevent an electromagnetic wave from propagating in the edge region D21 even by employing any one of (i) a configuration in which merely the external post wall 14a1, which is located near the input part 10a, is used and (ii) a configuration in which merely the external post wall 14b1, which is located near the output part 10b, is used. Similarly, in Embodiment 1, a configuration is employed in which the external post wall 14a2, which is located near the input part 10a, and the external post wall 14a2, which is located near the output part 10b, are both used to prevent an electromagnetic wave from propagating in the edge region D22. However, one of these two external post walls 14a2 and 14b2 can be omitted. That is, it is possible to prevent an electromagnetic wave from propagating in the edge region D22 even by employing any one of (i) a configuration in which merely the external post wall 14a2, which is located near the input part 10a, is used and (ii) a configuration in which merely the external post wall 14b2, which is located near the output part 10b, is used.

### Verification of Effect

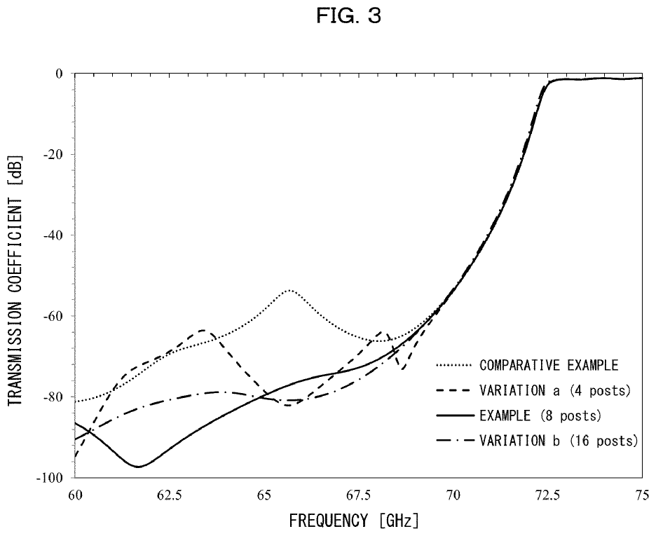

In regard to a bandpass filter 1 which was designed to have a passband of 72 GHz to 76 GHz, a result of calculating frequency dependence of a transmission coefficient (S21) by electromagnetic field simulation is shown as an Example in FIG. 3. Note that, in the Example, each of external post walls 14a1, 14a2, 14b1, and 14b2 was constituted by 8 conductor posts, as illustrated in FIGS. 1 and 2. FIG. 3 also shows results of calculation made in regard to the following Variations and a Comparative Example.

Variation a: each of external post walls 14a1, 14a2, 14b1, and 14b2 was constituted by 4 conductor posts.

Variation b: each of external post walls 14a1, 14a2, 14b1, and 14b2 was constituted by 16 conductor posts.

Comparative Example: external post walls 14a1, 14a2, 14b1, and 14b2 were omitted.

It is found, from FIG. 3, that transmission coefficients in the Example and the Variation b are each lower than that in the Comparative Example in an entire cutoff band on a low-frequency side. Moreover, it is found, from FIG. 3, that a transmission coefficient in the Variation a is lower than that in the Comparative Example in most part of the cutoff band on the low-frequency side. This indicates that a bypass phenomenon which occurred in the Comparative Example was suppressed by the external post walls 14a1, 14a2, 14b1, and 14b2 in the bandpass filter 1.

### Embodiment 2

(Configuration of Bandpass Filter)

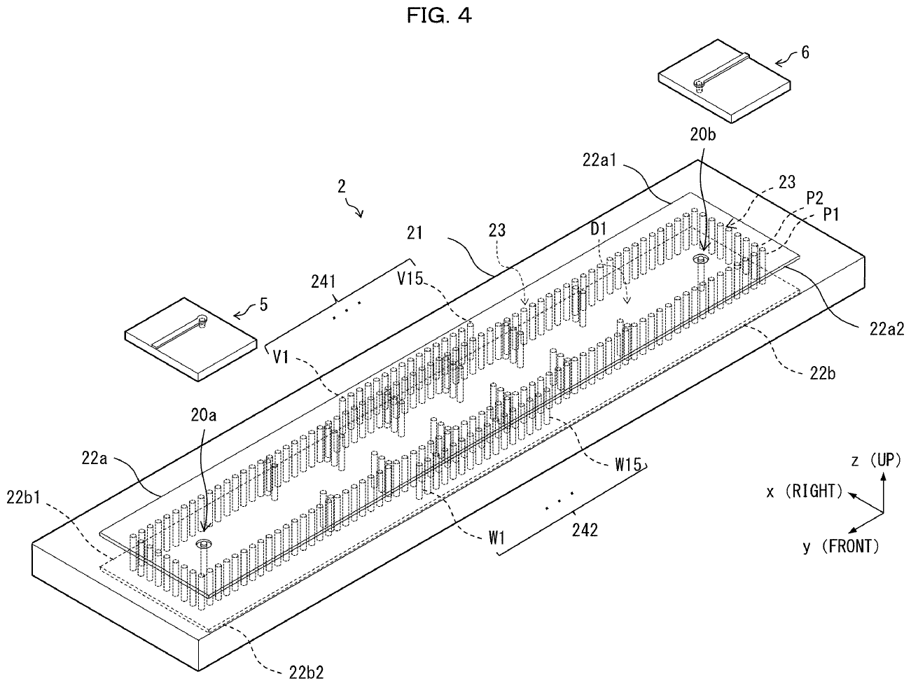

The following description will discuss a configuration of a bandpass filter 2 in accordance with Embodiment 2 of the present invention with reference to FIGS. 4 and 5. FIG. 4 is an exploded perspective view of the bandpass filter 2. (a) of FIG. 5 is a plan view of the bandpass filter 2. (b) of FIG. 5 is a cross-sectional view of the bandpass filter 2. Note that FIG. 4 also illustrates a first microstrip line 5 and a second microstrip line 6 which are to be connected to the bandpass filter 2. Note also that a cross section illustrated in (b) of FIG. 5 is a cross section of the bandpass filter 2 taken along a C-C′ line illustrated in (a) of FIG. 5.

As illustrated in FIG. 4, the bandpass filter 2 includes (1) a dielectric substrate 21, (2) an upper wide wall 22a (an example of the “first wide wall” recited in the claims) provided on an upper surface (an example of the “first main surface” recited in the claims) of the dielectric substrate 21, (3) a lower wide wall 22b (an example of the “second wide wall” recited in the claims) provided on a lower surface (an example of the “second main surface” recited in the claims) of the dielectric substrate 21, (4) a post wall 23 provided inside the dielectric substrate 21 and in a region in which the upper wide wall 22a and the lower wide wall 22b overlap each other in a plan view, and (5) external post walls 241 and 242 provided inside the dielectric substrate 21 and in a region in which an outer periphery of the upper wide wall 22a and an outer periphery of the lower wide wall 22b overlap each other in a plan view. The dielectric substrate 21, the upper wide wall 22a, the lower wide wall 22b, and the post wall 23 of the bandpass filter 2 are configured similarly to the dielectric substrate 11, the upper wide wall 12a, the lower wide wall 12b, and the post wall 13, respectively, of the bandpass filter 1. Therefore, the dielectric substrate 21, the upper wide wall 22a, the lower wide wall 22b, and the post wall 23 will not be described here.

The external post wall 241 is constituted by a single conductor post or a set of conductor posts (in Embodiment 2, 15 conductor posts V1, V2, . . . , V15), which are located outside a waveguide region D1 and on a right side of part, located midway between an input part 20a and an output part 20b, of the waveguide region D1 and which short-circuit a right outer periphery of the upper wide wall and a right outer periphery of the lower wide wall. These conductor posts V1, V2, . . . , V15 are configured similarly to conductor posts P1, P2, . . . , which constitute the post wall 23, and the external post wall 241 functions as a conductor wall which reflects an electromagnetic wave having a wavelength sufficiently longer than a post interval of the external post wall 241. Note that a distance from a central axis of each conductor post Vi (i=1, 2, . . . , 15) to a right outer edge 22a1 of the upper wide wall 12a and a distance from the central axis of each conductor post Vi (i=1, 2, . . . , 15) to a right outer edge 22b1 of the lower wide wall 12b are each set so as to be not more than a post interval of the post wall 23.

The external post wall 242 is constituted by a single conductor post or a set of conductor posts (in Embodiment 2, 15 conductor posts W1, W2, . . . , W15), which are located outside the waveguide region D1 and on a left side of the part, located midway between the input part 20a and the output part 20b, of the waveguide region D1 and which short-circuit a left outer periphery of the upper wide wall 12a and a left outer periphery of the lower wide wall 12b. These conductor posts W1, W2, . . . , W15 are configured similarly to the conductor posts P1, P2, . . . , which constitute the post wall 23, and the external post wall 242 functions as a conductor wall which reflects an electromagnetic wave having a wavelength sufficiently longer than a post interval of the external post wall 242. Note that a distance from a central axis of each conductor post Vi (i=1, 2, . . . , 15) to a left outer edge 22a2 of the upper wide wall 12a and a distance from the central axis of each conductor post Vi (i=1, 2, . . . , 15) to a left outer edge 22b2 of the lower wide wall 12b are each set so as to be not more than the post interval of the post wall 23.

(Features of Bandpass Filter)

It is noteworthy that the bandpass filter 2 in accordance with Embodiment 2 has the following configuration.

(1) The external post wall 241 is provided which is constituted by the conductor posts V1, V2, . . . , V15, which are located outside the waveguide region D1 and on the right side of the part, located midway between the input part 20a and the output part 20b, of the waveguide region D1 and which short-circuit the outer periphery of the upper wide wall 22a and the outer periphery of the lower wide wall 22b (specifically, short-circuit a middle part of the right outer periphery of the upper wide wall 22a and a middle part of the right outer periphery of the lower wide wall 22b).

(2) The external post wall 242 is provided which is constituted by the conductor posts W1, W2, . . . , W15, which are located outside the waveguide region D1 and on the side of the part, located midway between the input part 20a and the output part 20b, of the waveguide region D1 and which short-circuit the outer periphery of the upper wide wall 22a and the outer periphery of the lower wide wall 22b (specifically, short-circuit a middle part of the left outer periphery of the upper wide wall 22a and a middle part of the left outer periphery of the lower wide wall 22b).

According to the above configuration, each of the external post walls 241 and 242 prevents an electromagnetic wave from propagating in an edge region which is sandwiched between the outer periphery of the upper wide wall 22a and the outer periphery of the lower wide wall 22b. More specifically, the external post wall 241 prevents an electromagnetic wave from propagating in an edge region D21 (see FIG. 5) which is a region and a vicinity thereof which region is sandwiched between the right outer periphery of the upper wide wall 22a and the right outer periphery of the lower wide wall 22b. The external post wall 242 prevents an electromagnetic wave from propagating in an edge region D22 (see FIG. 5) which is a region and a vicinity thereof which region is sandwiched between the left outer periphery of the upper wide wall 22a and the left outer periphery of the lower wide wall 22b. Therefore, a bypass phenomenon is less likely to occur in the bandpass filter 2 in accordance with Embodiment 2. That is, in the bandpass filter 2 in accordance with Embodiment 2, a phenomenon is less likely to occur in which part of an electromagnetic wave that should be guided from the first microstrip line 5 to the second microstrip line 6 through the waveguide region D1 is guided from the first microstrip line 5 to the second microstrip line 6 through any of the edge regions D21 and D22, as compared with the bandpass filter 9 which is conventional bandpass filter.

Note that, in Embodiment 2, a configuration is employed in which the external post wall 241, which is for preventing an electromagnetic wave from propagating in the edge region D21, and the external post wall 242, which is for preventing an electromagnetic wave from propagating in the edge region D22, are both used. However, one of these two external post walls 241 and 242 can be omitted. That is, it is possible to suppress a bypass phenomenon even by employing any one of (i) a configuration in which merely the external post wall 241, which is for preventing an electromagnetic wave from propagating in the edge region D21, is used and (ii) a configuration in which merely the external post wall 242, which is for preventing an electromagnetic wave from propagating in the edge region D22, is used.

### Verification of Effect

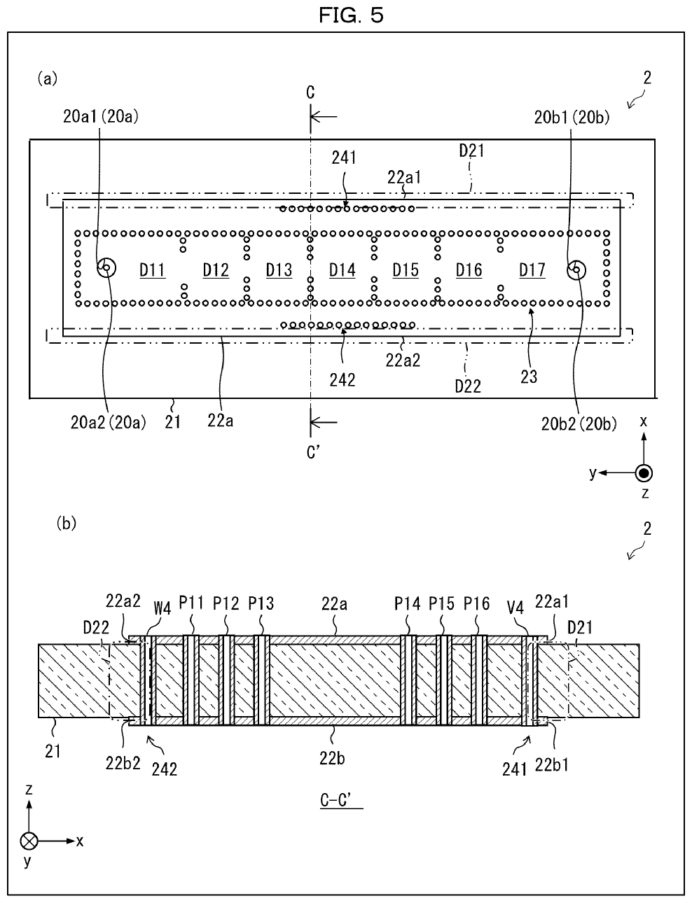

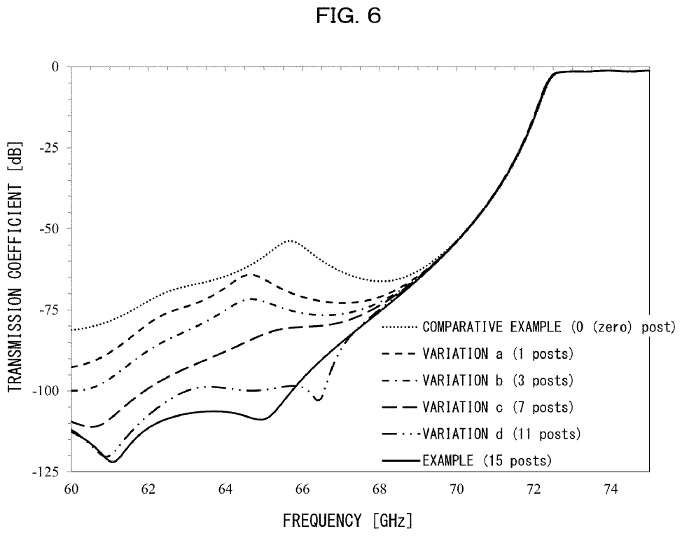

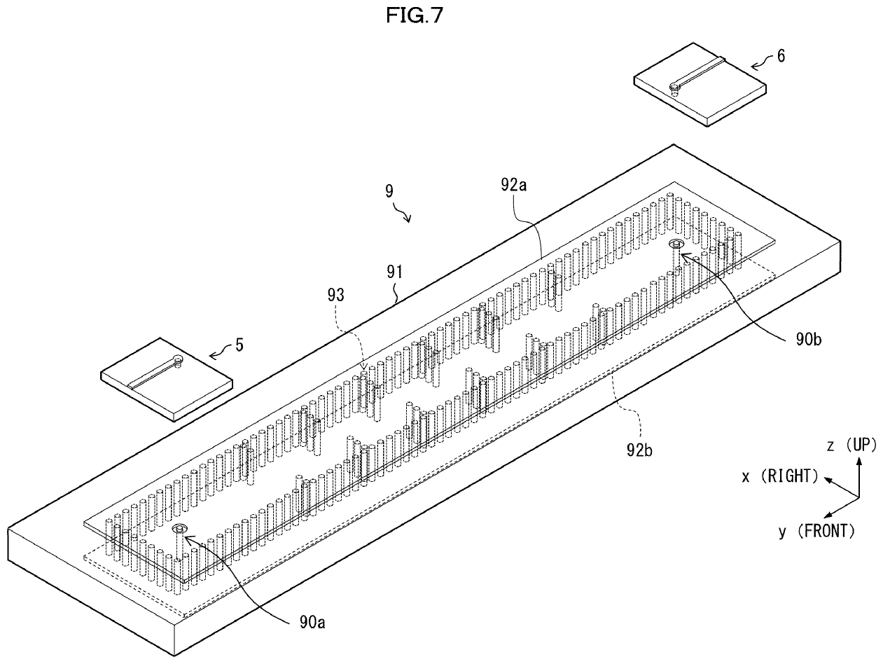

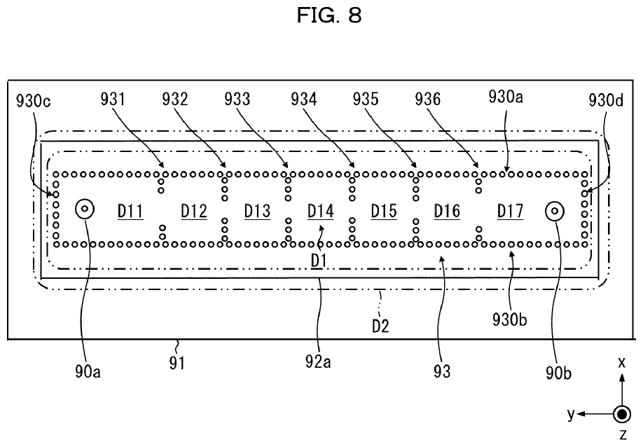

In regard to a bandpass filter 2 which was designed to have a passband of 72 GHz to 76 GHz, a result of calculating frequency dependence of a transmission coefficient (S21) by electromagnetic field simulation is shown as an Example in FIG. 6. Note that, in the Example, each of external post walls 241 and 242 was constituted by 15 conductor posts, as illustrated in FIGS. 4 and 5. FIG. 6 also shows results of calculation made in regard to the following Variations and a Comparative Example.

Variation a: each of external post walls 241 and 242 was constituted by a single conductor post.

Variation b: each of external post walls 241 and 242 was constituted by 3 conductor posts.

Variation c: each of external post walls 241 and 242 was constituted by 7 conductor posts.

Variation d: each of external post walls 241 and 242 was constituted by 11 conductor posts.

Comparative Example: external post walls 241 and 242 were omitted.

It is found, from FIG. 6, that transmission coefficients in the Example and the Variations a through d are each lower than that in the Comparative Example in an entire cutoff band on a low-frequency side. This indicates that a bypass phenomenon which occurred in the Comparative Example was suppressed by the external post walls 241 and 242 in the bandpass filter 2.

Aspects of the present invention can also be expressed as follows:

A bandpass filter (1, 2) in accordance with an aspect of the present invention is a bandpass filter (1, 2) including: a dielectric substrate (11, 21); a first wide wall (12a, 22a) which is provided on a first main surface of the dielectric substrate (11, 21); a second wide wall (12b, 22b) which is provided on a second main surface of the dielectric substrate (11, 21); a post wall (13, 23) which is provided inside the dielectric substrate (11, 21); an input part (10a, 20a) via which an electromagnetic wave is inputted; and an output part (10b, 20b) via which the electromagnetic wave is outputted, a waveguide region (D1) in which the electromagnetic wave inputted via the input part (10a, 20a) is guided and which includes a plurality of resonance regions being defined inside the dielectric substrate (11, 21) by the first wide wall (12a, 22a), the second wide wall (12b, 22b), and the post wall (13, 23), an external post wall (14a1, 14a2, 14b1, 14b2, 241, 242) which is constituted by at least one conductor post being provided outside the waveguide region (D1) and short-circuiting an outer periphery of the first wide wall (12a, 22a) and an outer periphery of the second wide wall (12b, 22b).

According to the above configuration, the external post wall prevents an electromagnetic wave from propagating in an edge region which is a region and a vicinity thereof which region is sandwiched between an outer edge of the first wide wall and an outer edge of the second wide wall. Therefore, according to the above configuration, it is possible to suppress a bypass phenomenon which occurs by the edge region serving as a bypass.

The bandpass filter (1) in accordance with an aspect of the present invention is arranged such that the external post wall (14a1, 14a2) includes an external post wall (14a1, 14a2) which is constituted by at least one conductor post that is provided on a side of the input part (10a) and that short-circuits the outer periphery of the first wide wall (12a) and the outer periphery of the second wide wall (12b).

According to the above configuration, it is possible to effectively suppress a bypass phenomenon which occurs by the edge region serving as a bypass.

The bandpass filter (1) in accordance with an aspect of the present invention is arranged such that the external post wall (14b1, 14b2) includes an external post wall (14b1, 14b2) which is constituted by at least one conductor post that is provided on a side of the output part (10b) and that short-circuits the outer periphery of the first wide wall (12a) and the outer periphery of the second wide wall (12b).

According to the above configuration, it is possible to effectively suppress a bypass phenomenon which occurs by the edge region serving as a bypass.

The bandpass filter (2) in accordance with an aspect of the present invention is arranged such that the external post wall (241, 242) includes an external post wall (241, 242) which is constituted by at least one conductor post that is provided on a side of part, located midway between the input part (20a) and the output part (20b), of the waveguide region and that short-circuits the outer periphery of the first wide wall (22a) and the outer periphery of the second wide wall (22b).

According to the above configuration, it is possible to more effectively suppress a bypass phenomenon which occurs by the edge region serving as a bypass.

The bandpass filter (1, 2) in accordance with an aspect of the present invention is arranged such that a distance from the at least one conductor post, which constitutes the external post wall (14a1, 14a2, 14b1, 14b2, 241, 242), to an outer edge of the first wide wall (12a, 22a) and a distance from the at least one conductor post, which constitutes the external post wall (14a1, 14a2, 14b1, 14b2, to an outer edge of the second wide wall (12b, 22b) are each set so as to be not more than a post interval between conductor posts which constitute the post wall (13, 23).

According to the above configuration, the external post wall makes it possible to effectively prevent an electromagnetic wave from propagating in the edge region which is sandwiched between the outer periphery of the first wide wall and the outer periphery of the second wide wall.

[Supplementary Note]

The present invention is not limited to the embodiments, but can be altered by a skilled person in the art within the scope of the claims. The present invention also encompasses, in its technical scope, any embodiment derived by combining technical means disclosed in differing embodiments. For example, the present invention encompasses, in its technical scope, an embodiment derived by combining the technique disclosed in Embodiment 1 and the technique disclosed in Embodiment 2, that is, a bandpass filter configured to include (i) post walls each of which is located near a corresponding one of an input part and an output part and each of which extends along part of an outer periphery of an upper wide wall and part of an outer periphery of a lower wide wall and (ii) a post wall which is located midway between the input part and the output part and which extends along part of the outer periphery of the upper wide wall and part of the outer periphery of the lower wide wall.

### REFERENCE SIGNS LIST

1, 2 Bandpass filter
11 Dielectric substrate
12a Upper wide wall (first wide wall)
12b Lower wide wall (second wide wall)
13 Post wall
14a1, 14a2, 14b1, 14b2 Post wall
2 Bandpass filter
21 Dielectric substrate
22a Upper wide wall (first wide wall)
22b Lower wide wall (second wide wall)
23 Post wall
241, 242 Post wall
D1 Waveguide region
D21, D22 Edge region

1. A bandpass filter comprising:
a dielectric substrate;
a first wide wall which is provided on a first main surface of the dielectric substrate;
a second wide wall which is provided on a second main surface of the dielectric substrate;
a post wall which is provided inside the dielectric substrate;
an input part via which an electromagnetic wave is inputted; and
an output part via which the electromagnetic wave is outputted,
a waveguide region in which the electromagnetic wave inputted via the input part is guided and which includes a plurality of resonance regions being defined inside the dielectric substrate by the first wide wall, the second wide wall, and the post wall,
an external post wall which is constituted by at least one conductor post being provided outside the waveguide region and short-circuiting an outer periphery of the first wide wall and an outer periphery of the second wide wall.

2. The bandpass filter as set forth in claim 1, wherein the external post wall includes an external post wall which is constituted by at least one conductor post that is provided outside the waveguide region and on a side of the input part and that short-circuits the outer periphery of the first wide wall and the outer periphery of the second wide wall.

3. The bandpass filter as set forth in claim 1, wherein the external post wall includes an external post wall which is constituted by at least one conductor post that is provided outside the waveguide region and on a side of the output part and that short-circuits the outer periphery of the first wide wall and the outer periphery of the second wide wall.

4. The bandpass filter as set forth in claim 1, wherein the external post wall includes an external post wall which is constituted by at least one conductor post that is provided outside the waveguide region and on a side of part, located midway between the input part and the output part, of the waveguide region and that short-circuits the outer periphery of the first wide wall and the outer periphery of the second wide wall.

5. The bandpass filter as set forth in claim 1, wherein a distance from the at least one conductor post, which constitutes the external post wall, to an outer edge of the first wide wall and a distance from the at least one conductor post, which constitutes the external post wall, to an outer edge of the second wide wall are each set so as to be not more than a post interval of the post wall.
